(19) United States
(12) Patent Application Publication
(10) Pub. No.: US 2014/0318278 A1
(43) Pub. Date: Oct. 30, 2014

(54) PARTICLE IMAGING UTILIZING A FILTER

(71) Applicant: Honeywell International Inc., Morristown, NJ (US)

(72) Inventors: Elizabeth Palaima, St. Paul, MN (US); Kylin Hoehn, Saint Paul, MN (US); Steve Burris, Minneapolis, MN (US); Lynn Seifried, Minneapolis, MN (US); Pamela Wong, White Bear Lake, MN (US)

(21) Appl. No.: 13/869,880

(22) Filed: Apr. 24, 2013

(51) Int. Cl. G01N 1/22

(52) U.S. Cl. CPC G01N 1/2205
USPC 73/863.23

(57) ABSTRACT

A multiple layer test card including an input channel formed in a layer of the test card, an output channel formed in another layer of the test card, and a filter coupled between the input channel and the output channel to receive fluid from the first channel and collect white blood cells such that the collected white blood cells are optically visible proximate a first surface of the filter.

### BACKGROUND

Particles, such as white blood cells are counted and differentiated for use in medical studies and diagnostic testing. Microfluidic structures have been used to isolate white blood cells on slides or in cuvettes. However, the slides and cuvettes have not provided an easy effective mechanism to quickly and accurately count and differentiate white blood cells.

### SUMMARY

A multiple layer test card including an input channel formed in a layer of the test card, an output channel formed in another layer of the test card, and a filter coupled between the input channel and the output channel to receive fluid from the input channel and collect particles such that the collected particles are optically visible proximate a first surface of the filter.

A method includes providing a fluid containing particles of interest to a microfluidic input channel on a layer of a multiple layer laminated test card, moving the fluid through the input channel and over a filter on a filter layer of the test card, and collecting the particles of interest on the filter.

A further method includes forming an input channel in an input layer of a multiple layer test card, forming a filter in a filter layer of the multiple layer test card, forming a waste channel in a output layer of the multiple layer test card, providing a capping layer for each of the input channel and waste channel, and attaching the layers together such that the input channel opens onto a first side of the filter and the waste channel opens onto a second side of the filter opposite the first side such that particles in the fluid are collected on the filter as the fluid is moved over the filter.

### BRIEF DESCRIPTION OF THE DRAWINGS

FIG. 1 is a top view representation of a card having a filter according to an example embodiment.

FIG. 2 is a side cross section representation of the card of FIG. 1 taken along lines 2-2 according to an example embodiment.

FIG. 3 is a flowchart representation of a method of using a test card according to an example embodiment.

FIG. 4 is a flowchart representation of a method of manufacturing a multiple layer test card according to an example embodiment.

FIG. 5 is an exploded view of an alternative cartridge having a filter according to an example embodiment.

FIG. 6 is an exploded view of a filter assembly according to an example embodiment.

FIG. 7 is a top view of the filter of FIG. 6 that illustrates example dimensions of the filter

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

White cells are important to immune system and function. Both white cell counts and differentiation are used in medical studies. A filter allows one to stain and image a liquid sample of varying sizes containing white cells for further analysis such as differentiation of a sample utilizing a relatively small area. The filter provides additional flexibility of use to the system, and may also be used to collect and image many different types of particles of interest.

In various embodiments a screen or filter is used increase the concentration of particles of interest. The filter is then ready to be viewed to facilitate detection of a small number of particles from varying sample sizes, viewing only a small surface area. Furthermore since the particles can be stained on or before the filter they can be easily detected and possibility differentiated.

In some embodiments, the filter material may be a polycarbonate filter or other non-fibrous filter material. The filter provides a surface that can be dried which provides an opportunity for fixation and staining if desired. Previous attempts to provide an automated system to image white cells utilized cuvettes or slides. These are not as nearly as adaptable as the filter for use in an automated system with varying sample sizes.

Microfluidic cards may be assembled using filters and different combination of materials. After constructing the cards, in one embodiment, blood is pulled or pushed into a sample input channel to one side of the filter combinations mentioned above and then applied over the filter.

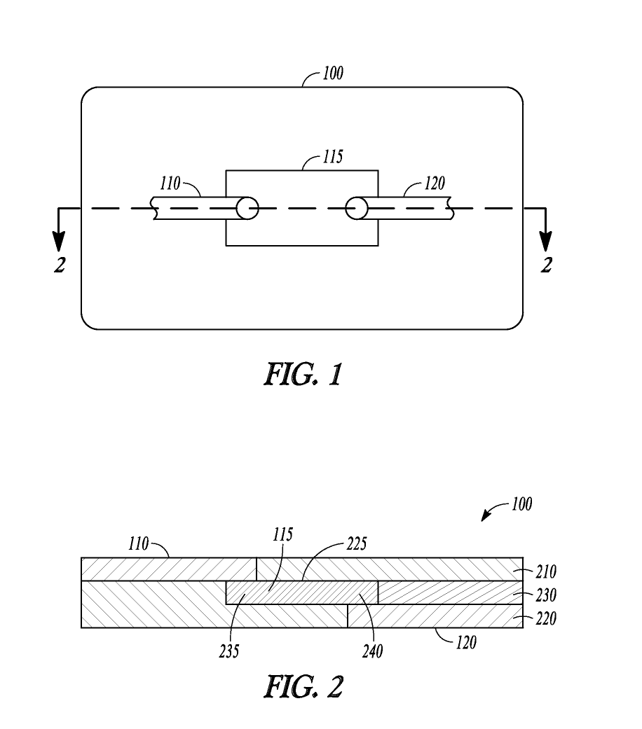

FIG. 1 is a block diagram planar view representation of a multiple layer test card 100. FIG. 2 is a cross section of the test card 100 taken along lines 2-2 in FIG. 1, with consistent number of elements. The figures are not to scale. In some embodiments, the test card 100 contains many layers of a transparent material such as PET or acrylic or other suitable material that can be patterned with various liquid fluid transport features. The card 100 in some embodiments may be used to perform one or more blood tests utilizing a small volume of blood. The blood or other liquid to be tested, may be transported via one or more layers of the test card, and prepared for analysis by a test instrument into which the card is inserted A combination of LEDs, lasers, and other light sources may be used to illuminate the sample.

In one embodiment, card 100 includes an input channel 110 formed in an input layer 210 of the test card. A waste channel 120 is formed in a waste layer 220 of the test card 100. A filter 115 is coupled between the input channel and the waste channel to receive fluid from the input channel and collect particles such as white blood cells such that the collected particles are optically visible proximate a first surface 225 of the filter 115. The filter 115 may be deposited within a cut out area of a filter layer 225, or may be simply sandwiched between the input layer 210 and waste layer 220 in various embodiments. Further layers may provide a capping function for the channels.

The input channel 110 provides the fluid proximate a first portion 235 of a length of the filter 115, and the waste channel receives fluid passed through the filter 115 proximate a second portion 240 of the length of the filter. The first and second portions of the length of the filter may be separated along the length of the filter. In further embodiments, the first and second portions overlap.

In one embodiment, the filter is optically visible at least along a portion of the filter between the first and second portions of the filter. The layers of the card may be transparent to facilitate visibility of the filter through the layers.

In one embodiment, the filter or the channel before the filter 115 includes a stain to stain the collected particles such as white blood cells. The stain may be formed of acridine orange, other nucleic acid stain, or stain that differentiates white cells. The filter may have a pore size of between 2 and 5 μm in some embodiments, and larger or smaller pore sizes in further embodiments. The filter is formed of non-fibrous filter material. One example filter is a polycarbonate filter.

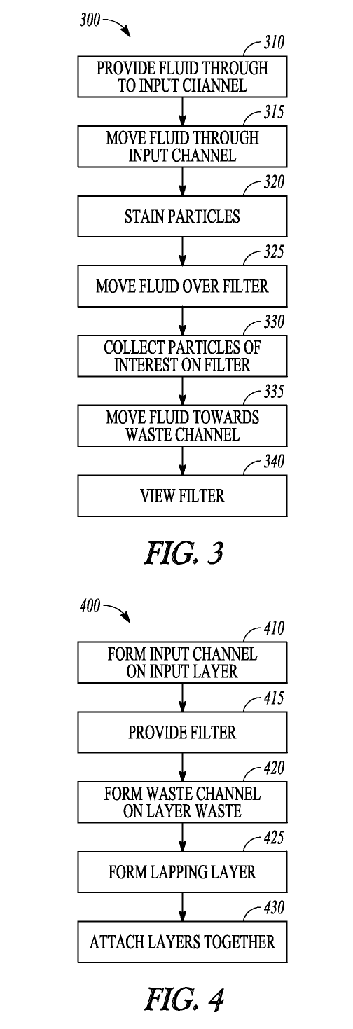

FIG. 3 is a flowchart of a method 300 of using a test card. At 310, fluid containing particles of interest are provided to a microfluidic input channel on a layer of a multiple layer test card. At 315, the fluid is moved through the input channel and particles are stained at 320. The fluid then moves over a filter at 325 on a filter layer of the test card. At 330, particles of interest are collected on the filter. The fluid is moved at 335 from the filter towards a waste channel in a waste channel layer of the test card.

In one embodiment, the fluid is moved via negative or positive pressure provided via a test system in which the card has been inserted. The filter or input channel before the filter may contain stain, such that the particles of interest that are collected on the filter are stained at or before 325 to make them more easily visible. In some embodiments, the particles of interest are stained by acridine orange. The acridine orange may be contained on the filter or the channel before the filter. The fluid in one embodiment comprises blood and the particles of interest comprise white blood cells. The filter may be viewed or imaged at 340 to provide an image from which differentiation of cells may be performed, either via image analysis or by human analysis.

FIG. 4 is a flowchart illustrating a method 400 of building a card. At 410, an input channel is formed in an input layer of a multiple layer test card. A filter is formed in a filter layer of the multiple layer test card at 415. Alternatively, a filter is provided without a corresponding filter layer. At 420, a waste channel is formed in a waste layer of the multiple layer test card. In one embodiment, the channels are cut from the layers via a laser. A capping layer is formed for each of the input channel and waste channel at 425 by providing a layer that has material corresponding to channels to cover the channels when the layers are assembled together. At 430, the layers are attached together such that the input channel opens onto a first side of the filter and the waste channel opens onto a second side of the filter opposite the first side such that particles in the fluid are collected on the filter as the fluid is moved over the filter. The layers may be attached by a laminating process, double sided adhesive layers having corresponding cut out areas to allow fluid to move between adjacent layers where intended, or other mechanisms, such as clamping between stiff layers. Some cards or layers to be attached may also be made via one or more injection molding processes.

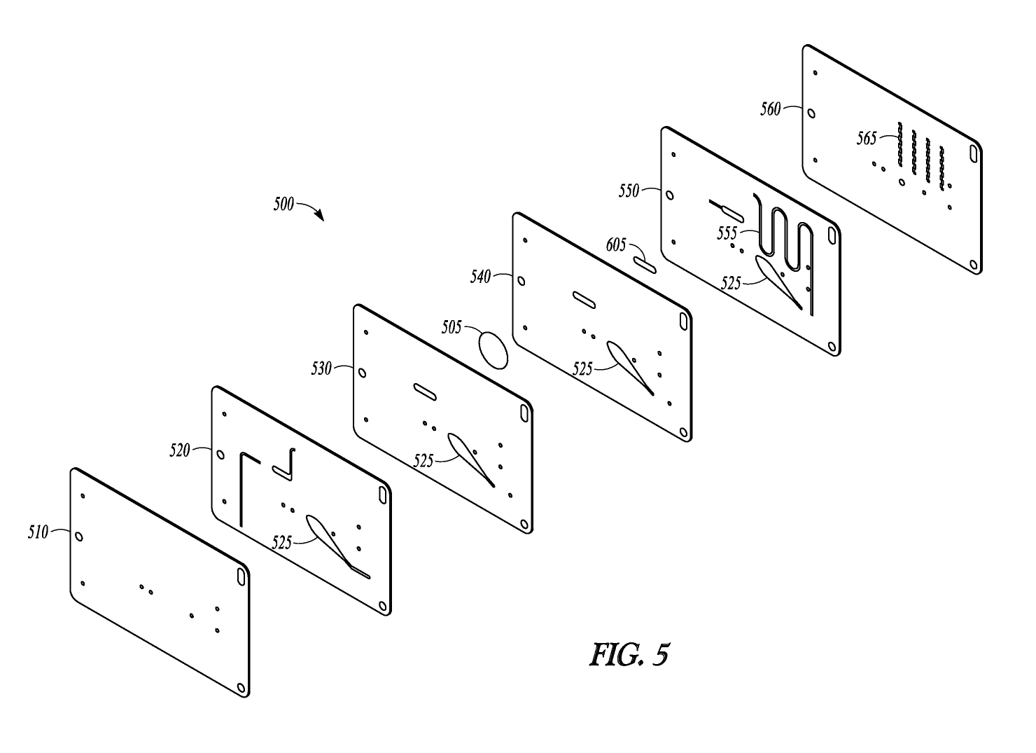

FIG. 5 is an exploded view of an alternative cartridge 500 having a filter 505 according to an example embodiment. Six layers, 510, 520, 530, 540, 550, and 560 are shown with various features that when assembled provide a fluid having particles, such as white blood cells to the filter 505, which is sandwiched between layers 530 and 540. In one embodiment, blood is received in a sample well 525, that has a depth of four layers 520, 530, 540, 550. The fluid proceeds through a serpentine path 555 as seen on layer 550. Remaining white blood cells are transported to a first side of filter 505, which collects the particles. Remaining fluid moves over the filter to one or more waste channels. In this embodiment, the filter 505 is simply sandwiched between two layers.

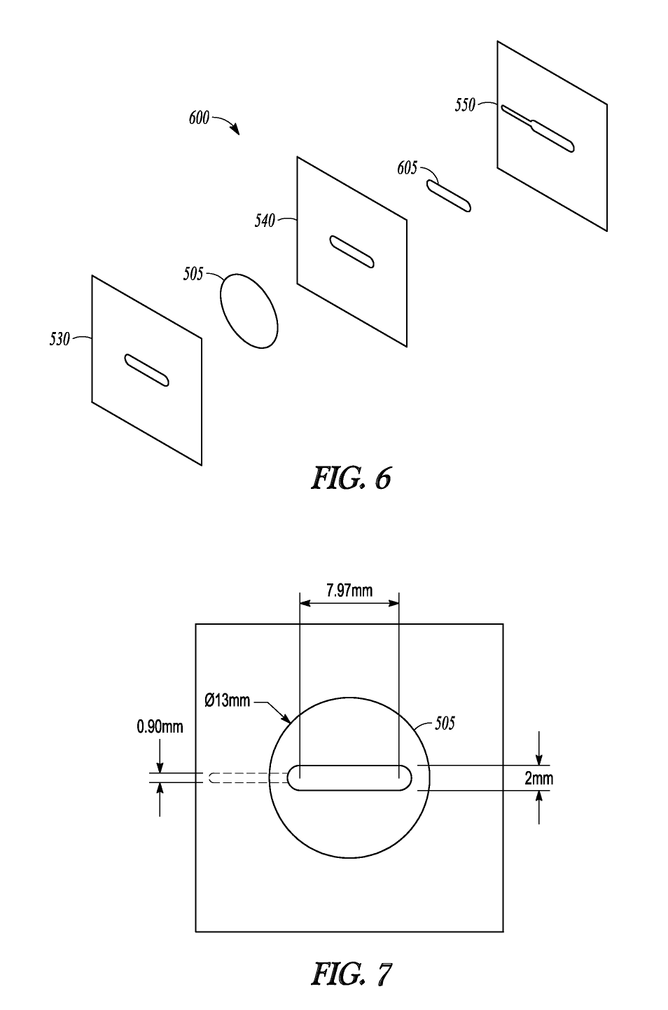

FIG. 6 is an exploded view of a filter assembly according to an example embodiment. An absorbent pad 605 may be included and is shown between layers 640 and 650. Pad 605 may be positioned to support the filter and better present the particles in the openings of the layers adjacent the filter 605. FIG. 7 is a top view of the filter 605 that illustrates example dimensions of the filter 605 and channels on either side in adjacent layers that sandwich the filter.

### Examples

1. A multiple layer test card comprising:
an input channel formed in a first layer of the test card;
an output channel formed in a second layer of the test card; and
a filter coupled between the input and output channels to receive fluid from the input channel and collect particles such that the collected particles are optically visible proximate a first surface of the filter.

2. The multiple layer test card of example 1 wherein the filter or the input channel includes a stain to stain the collected particles comprising white blood cells.

3. The multiple layer test card of example 2 wherein the stain comprises acridine orange.

4. The multiple layer test card of any of examples 2-3 wherein the stain comprises a nucleic acid stain, a pH sensitive stain, or a stain that differentiates white cells.

5. The multiple layer test card of any of examples 1-4 wherein the filter has a pore size of between 2 and 5 μm.

6. The multiple layer test card of example 5 wherein the input channel provides the fluid proximate a first portion of a length of the filter, and the output channel receives fluid passed over the filter proximate a second portion of the length of the filter.

7. The multiple layer test card of example 6 wherein the first and second portions of the length of the filter are separated along the length of the filter.

8. The multiple layer test card of example 7 wherein the filter is optically visible at least along a portion of the filter between the first and second portions of the filter.

9. The multiple layer test card of any of examples 1-8 wherein the filter is formed of non-fibrous filter material.

10. The multiple layer test card of any of examples 1-9 wherein the filter comprises a polycarbonate filter.

11. The multiple layer test card of any of examples 1-10 and further comprising an absorbent pad disposed to support the filter.

12. A method comprising:
providing a fluid containing particles of interest to a microfluidic input channel on a layer of a multiple layer laminated test card;
moving the fluid through the input channel and over a filter on a filter layer of the test card;
collecting the particles of interest on the filter; and
moving the fluid from the filter towards a waste channel in a waste channel layer of the test card.

13. The method of example 12 wherein moving the fluid is moved via negative or positive pressure.

14. The method of any of examples 12-13 and further comprising staining the particles of interest that are collected on the filter.

15. The method of example 14 wherein the particles of interest are stained by acridine orange.

16. The method of example 15 wherein the acridine orange is contained in at least one aspect of the input channel and or on the filter.

17. The method of any of examples 12-16 wherein the fluid comprises blood and the particles of interest comprise white blood cells.

18. The method of any of examples 12-17 wherein the filter has a pore size of between 2 and 5 μm and wherein the input channel provides the fluid proximate a first portion of a length of the filter, and the waste channel receives fluid passed over the filter proximate a second portion of the length of the filter.

19. The method of any of examples 12-18 wherein the filter comprises a polycarbonate filter.

20. A method comprising:
forming an input channel in an input layer of a multiple layer test card;
forming a filter in a filter layer of the multiple layer test card;
forming a waste channel in a waste layer of the multiple layer test card;
providing a capping layer for each of the input channel and waste channel; and
attaching the layers together such that the input channel opens onto a first side of the filter and the waste channel opens onto a second side of the filter opposite the first side such that particles in the fluid are collected on the filter as the fluid is moved over the filter.

21. The method of example 20 wherein forming the channels comprises cutting the channels in each layer with a laser.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A multiple layer test card comprising:
an input channel formed in a layer of the test card;
an output channel formed in another layer of the test card; and
a filter coupled between the input channel and the output channel to receive fluid from the input channel and collect particles such that the collected particles are optically visible proximate a first surface of the filter.

2. The multiple layer test card of claim 1 wherein the filter or the channel before the filter includes a stain to stain the particles comprising collected white blood cells.

3. The multiple layer test card of claim 2 wherein the stain comprises acridine orange.

4. The multiple layer test card of claim 2 wherein the stain comprises a nucleic acid stain, a pH sensitive stain, or a stain that differentiates white cells.

5. The multiple layer test card of claim 1 wherein the filter has a pore size of between 2 and 5 μm.

6. The multiple layer test card of claim 5 wherein the input channel provides the fluid proximate a first portion of a length of the filter, and the output channel receives fluid passed over the filter proximate a second portion of the length of the filter.

7. The multiple layer test card of claim 6 wherein the first and second portions of the length of the filter are separated along the length of the filter.

8. The multiple layer test card of claim 1 wherein the filter is formed of non-fibrous filter material.

9. The multiple layer test card of claim 1 wherein the filter comprises a polycarbonate filter.

10. The multiple layer test card of claim 1 and further comprising an absorbent support pad disposed to support the filter and better present particles.

11. A method comprising:
providing a fluid containing particles of interest to a microfluidic input channel on a layer of a multiple layer laminated test card;
moving the fluid through the input channel and over a filter on a filter layer of the test card;
collecting the particles of interest in the filter; and
moving the fluid from the filter towards a waste channel in a waste channel layer of the test card.

12. The method of claim 11 wherein moving the fluid is moved via negative or positive pressure.

13. The method of claim 11 and further comprising staining the particles of interest that are collected on the filter.

14. The method of claim 13 wherein the particles of interest are stained by acridine orange.

15. The method of claim 14 wherein the acridine orange is contained in at least one of the input channel and the filter.

16. The method of claim 11 wherein the fluid comprises blood and the particles of interest comprise white blood cells.

17. The method of claim 11 wherein the filter has a pore size of between 2 and 5 μm and wherein the input channel provides the fluid proximate a first portion of a length of the filter, and the waste channel receives fluid passed through the filter proximate a second portion of the length of the filter.

18. The method of claim 11 wherein the filter comprises a polycarbonate filter.

19. A method comprising:
forming an input channel in an input layer of a multiple layer test card;
forming a filter in a filter layer of the multiple layer test card;
forming a waste channel in a waste layer of the multiple layer test card;
providing a capping layer for each of the input channel and waste channel; and
attaching the layers together such that the input channel opens onto a first side of the filter and the waste channel opens onto a second side of the filter opposite the first side such that particles in the fluid are collected on the filter as the fluid is moved over the filter.

20. The method of claim 19 wherein forming the channels comprises cutting the channels in each layer with a laser.
